(19) United States
(12) Patent Application Publication
(10) Pub. No.: US 2016/0125568 A1
(43) Pub. Date: May 5, 2016

(54) MANAGEMENT OF MEMORY FOR STORING DISPLAY DATA

(71) Applicant: Jonathan Alexander JEACOCKE, Cambridge (GB)

(72) Inventor: Jonathan Alexander JEACOCKE, Bedford (GB)

(21) Appl. No.: 14/895,876

(22) PCT Filed: May 19, 2014
(86) PCT No.: PCT/GB2014/051532

§ 371 Date: Dec. 3, 2015

(30) Foreign Application Priority Data
Jun. 3, 2013 (GB) 1309874.4

(51) Int. Cl. G06T 1/60; G06T 9/00; G09G 5/00; G06T 1/20

(52) U.S. Cl. CPC G06T 1/60; G06T 1/20; G06T 9/00; G09G 5/001; G09G 5/006; G09G 2360/18; G09G 2360/122

(57) ABSTRACT

A method, at a display control device (16), of managing memory (28) of the display control device (16), the memory (28) being used for storing display data sent from a host device (10) to the display control device (16) for display. The method involves maintaining a map (18) at the display control device (16) corresponding to the memory (28), the map (18) indicating locations corresponding to addresses of the memory (28) at which data is stored or not. The map (18) is used to determine a size of a portion of the display data, and a location on the map (18) where the portion of display data would fit into the memory. The portion of received data is then stored at the location in the memory (28) and the location on the map (18) corresponding to the location in the memory (28) is updated to indicate that the address has data stored in it. Compression parameters may be selected by the display control device (16) and sent to the host device (10) so that the compressed portion of display data will fit into a free space in the memory (28) of the display control device (16).

The present invention relates to methods and apparatus for managing memory for storing display data, and more particularly, though not exclusively, for managing a memory storing compressed display data at a display control device.

In desktop computing, it is now common to use more than one display device.

Traditionally, a user would have a computer with a single display device attached, but now it is possible to have more than one display device attached to the computer, which increases the usable area for the worker. For example, International Patent Application Publication WO 20071020408 discloses a display system which comprises a plurality of display devices, each displaying respectively an image, a data processing device connected to each is display device and controlling the image displayed by each display device, and a user interface device connected to the data processing device. Connecting multiple display devices to a computer is a proven method for improving productivity.

The connection of an additional display device to a computer presents a number of problems. In general, a computer will be provided with only one video output such as a VGA-out connection. One method by which a display device can be added to a computer is by adding an additional graphics card to the internal components of the computer. The additional graphics card will provide an additional video output which will allow the display device to be connected to the computer and driven by that computer.

However, this solution is relatively expensive and is not suitable for many non-technical users of computers.

An alternative method of connecting a display device is to connect the display device to a USB socket on the computer, as all modern computers are provided with multiple USB sockets. This provides a simple connection topology, but requires additional hardware and software to be present, as in general, USB has a bandwidth that makes the provision of a good quality video output a non-trivial task.

As display technologies improve and the user's desire for display quality increases, the requirement placed upon the display control device that is receiving the incoming display data will correspondingly increase, as the amount of display data will increase proportionally. It is obviously desirable that any new display control devices can handle higher definition video inputs and higher resolution display devices.

GB 2485613 discloses a display control device that comprises a frame buffer store and a control component. The display control device is arranged to receive compressed display data, store the received compressed display data in the frame buffer store, and for each frame refresh of the display device access the stored compressed display data, decompress the accessed display data, and output the decompressed display data. Thus, the compressed data is stored in the frame buffer store without first being decompressed in the display control device.

Management of such a frame buffer store is needed, whether or not the display data is compressed. Therefore, aspects and examples of the invention are set out in the claims and address at least a part of the above described problem.

Examples of the invention may be implemented in software, middleware, firmware or hardware or any combination thereof. Embodiments of the invention comprise computer program products comprising program instructions to program a processor to perform one or more of the methods described herein, such products may be provided on computer readable storage media or in the form of a computer readable signal for transmission over a network. Embodiments of the invention provide computer readable storage media and computer readable signals carrying data structures, media data files or databases according to any of those described herein.

Apparatus aspects may be applied to method aspects and vice versa. The skilled reader will appreciate that apparatus embodiments may be adapted to implement features of method embodiments and that one or more features of any of the embodiments described herein, whether defined in the body of the description or in the claims, may be independently combined with any of the other embodiments described herein.

In a first aspect the invention provides a method of managing variable size memory of a display control device connectable to a host device, the memory being used for storing display data sent from the host device to the display control device for displaying on a display, the method comprising:

maintaining a map at the display control device corresponding to the memory, the map indicating locations corresponding to addresses of the memory at which data is stored or not;

receiving a portion of the display data from the host device;

determining a size of the portion of the display data, the size being variable for different portions of data;

determining a location on the map where the portion of display data would fit into the memory;

determining an address in the memory corresponding to the determined location on the map;

storing the portion of display data at the determined address in the memory; and

updating the location on the map corresponding to the address in the memory to indicate that the address has data stored in it.

Preferably, the method further comprises determining free space available in the memory based on the map.

The memory preferably comprises a frame buffer memory for storing a frame of image data.

In one embodiment, the received portion of display data is compressed at the host device using compression parameters.

The method may further comprise receiving, from the host device, information regarding a size of an uncompressed portion of display data, selecting compression parameters, and providing the selected compression parameters to the host device.

Preferably, the compression parameters are selected so that the compressed portion of display data will fit into a free space in the frame buffer memory of the display control device.

The compression parameters are preferably selected so that the compressed portion of display data has an optimum quality.

Selecting compression parameters so that that the compressed portion of display data has an optimum quality preferably comprises determining that the compression is too high and selecting compression parameters to reduce the compression,

The selected compression parameters preferably comprise quantisation parameters.

In one embodiment, the method further comprises determining, based on the map, whether the frame buffer memory of the display control device is expected to run out of space, and if it is determined that the frame buffer memory of the display control device is expected to run out of space, adjusting the compression parameters in order to increase the compression of the display data.

The adjusted compression parameters preferably comprise quantisation parameters.

The map may corresponds to two or more frame buffers in the frame buffer memory at the display control device. The frame buffers may be of equal or unequal size.

The method preferably further comprises maintaining information regarding an order in which the portions of display data in the memory are to be accessed from the memory and combined to display an image on the display.

According to a second aspect, the invention provides a method of managing a random access memory of a display control device connectable to a host computing device, the memory being used for storing compressed display data forming parts of an image sent from the host device to the display control device, wherein the display control device decompresses the compressed display data from the memory for displaying on a display, the method comprising:

receiving, from the host device, information regarding a size of an uncompressed portion of display data;

determining free space available in the random access memory;

selecting compression parameters so that a compressed version of the uncompressed portion of display data will fit into a free space in the random access memory of the display control device;

providing the selected compression parameters to the host computing device;

determining an address in the memory corresponding to the determined free space in the memory;

receiving, from the host computer device, the compressed portion of display data compressed using the selected compression parameters;

storing the received compressed portion of display data at the determined address in the memory; and

maintaining, at the display control device, information regarding an order in which the portions of compressed display data in the memory are to be decompressed and combined to display the image on the display.

In an embodiment, the method further comprises receiving, from the host device, information regarding a size of a current frame of uncompressed display data, determining whether the memory of the display control device is expected to run out of space before all the uncompressed display data of a current frame is compressed, received and stored, and if it is determined that the memory of the display control device is expected to run out of space before all the display data of a current frame is compressed, received and stored, selecting different compression parameters in order to increase the compression of the display data so that all remaining uncompressed display data of the current frame will fit into the memory and providing the selected different compression parameters to the host device.

The method may further comprise:

selecting compression parameters so that the uncompressed portion of display data has an optimum quality when it has been compressed;

Preferably, selecting compression parameters so that the compressed portion of display data has an optimum quality comprises determining that the compression is too high and selecting compression parameters to reduce the compression,

In a third aspect, the invention provides a method of managing a random access memory of a display control device connectable to a host device, the memory being used for storing compressed display data forming parts of an image sent from the host device to the display control device, wherein the display control device decompresses the compressed data from the memory for displaying on a display, the method comprising:

receiving, from the host device, information regarding a size of an uncompressed portion of display data;

determining free space available in the memory;

determining whether the memory is expected to run out of space before all the display data of a current frame is compressed, received and stored;

selecting compression parameters so that all remaining uncompressed display data of the current frame will fit into the memory when it is compressed using the selected compression parameters;

providing the selected compression parameters to the host computing device;

receiving, from the host device, the compressed portion of display data compressed using the selected compression parameters;

storing the received compressed portion of display data in the memory; and

maintaining, at the display control device, information regarding an order in which the portions of compressed display data in the frame buffer memory are to be decompressed and combined to display the image on the display.

The method preferably further comprises maintaining a map at the display control device corresponding to the memory of the display control device, the map indicating locations corresponding to addresses of the memory at which data is stored or not.

Preferably, determining free space available in the memory comprises determining a location on the map where the compressed portion of display data would fit into the memory.

The method may further comprise updating the location on the map corresponding to the address in the memory to indicate that the address has data stored in it.

The map preferably corresponds to two or more frame buffers in the memory at the display control device. The frame buffers may be of equal or unequal size.

In an embodiment, the method further comprises selecting the compression parameters so that a frame of display data has an optimum quality when it has been compressed that can be received from the host computing device in a target time.

The method preferably further comprises selecting the compression parameters so that the portion of data can be received from the host device in a target time. The target time may be chosen to be less than a predetermined period.

In an embodiment, the method further comprises selecting the compression parameters so that a frame of display data has an optimum quality when it has been compressed that can be received from the host computing device based on resources available to transmit the compressed data to the display control device.

Preferably, if it is determined that the compressed portion of display data will not fit efficiently into the memory, then the display control device sends a command to the host computing device to compress all previous portions of display data for the frame again using different compression parameters to produce smaller portions of compressed data to be received at the display control device for storing in the memory replacing the previously received compressed portions of display data for the frame. The different compression parameters may comprise quantisation parameters.

In a further aspect, the invention provides a method of managing a memory of a display control device connectable to a host device, the memory being used for storing compressed display data sent from the host device to the display control device, wherein the display control device decompresses the compressed data from the memory for displaying on a display, the method comprising:

selecting, at the display control device, compression parameters so that a frame of uncompressed display data has an optimum quality when it has been compressed that can be received from the host computing device in a target time;
providing the selected compression parameters to the host computing device;

receiving, from the host computing device, a portion of display data compressed using the selected compression parameters; and

storing the received compressed portion of display data in the memory.

According to a still further aspect, the invention provides a method of managing a memory of a display control device connectable to a host computing device, the memory being used for storing compressed display data sent from the host device to the display control device, wherein the display control device decompresses the compressed data from the memory for displaying on a display, the method comprising:

selecting, at the display control device, compression parameters so that a frame of display data has an optimum quality when it has been compressed that can be received from the host device based on resources available to transmit the compressed data to the display control device;

providing the selected compression parameters to the host computing device;

receiving, from the host computing device, a portion of display data compressed using the selected compression parameters; and

storing the received compressed portion of display data in the memory.

In another aspect, the invention provides a method of managing a memory of a display control device connectable to a host device, the memory being used for storing compressed display data sent from the host device to the display control device, wherein the display control device decompresses the compressed data from the memory for displaying on a display, the method comprising:

selecting, at the display control device, compression parameters so that a portion of a frame of compressed data can be received from the host device in a target time;

providing the selected compression parameters to the host device;

receiving, from the host device, a portion of display data compressed using the selected compression parameters; and

storing the received compressed portion of display data in the memory.

The target time preferably may be chosen to be less than a predetermined period.

Preferably, selecting the compression parameters is based on a time taken for a previous frame of compressed data received from the host device.

According to one embodiment, the method further comprises receiving, from the host device, information regarding a size of a frame of uncompressed display data.

Selecting the compression parameters may be based on content of a previous frame of compressed data received from the host device.

According to yet another aspect, the invention provides a method of managing a memory of a display control device connectable to a host device, the memory being used for storing compressed display data sent from the host device to the display control device, wherein the display control device decompresses the compressed data from the memory for displaying on a display, the method comprising:

maintaining a map at the display control device corresponding to the memory of the display control device, the map indicating quality of portions of the display data stored at particular addresses in the memory;

determining when the quality of a portion of the display data previously received by the display control device was of low quality;

determining that resources are available to transmit the compressed portion of display data to the display control device in a higher quality;

selecting compression parameters so that the portion of the display data is of higher quality when it has been compressed;

providing the selected compression parameters to the host computing device;

receiving, from the host computing device, a portion of display data compressed using the selected compression parameters;

storing the received compressed portion of display data at an address in the memory; and

updating the quality on the map corresponding to the address in the memory where the portion of compressed display data having higher quality is stored.

The compressed portion of data is preferably packaged with a transport protocol before being sent to the display control device. The transport protocol may be an Internet Protocol, for example, TCP/IP protocol or USB protocol, or a wireless protocol, for example, WiFi Wireless protocol or WiGig protocol. The compressed portion of data is preferably packaged into a packet for sending to the display control device, the packet including the address, which address may be included in a header of the packet.

In one embodiment, the compressed portion of data comprises a partial update of the display data including only the display data that has changed from the previous frame. The compressed portion of data may comprise a tile of display data or a group of tiles of display data.

Preferably, the method further comprises decompressing the compressed portion of display data from the memory prior to combining the portions to form the image.

In a further aspect, the invention provides a display control device configured to perform a method as described above.

In a still further aspect, the invention provides a computer readable medium including executable instructions which, when executed in a processing system, cause the processing system to perform a method as described above.

Another aspect of the invention provides a display system comprising:

a host device;

a display control device configured to perform a method as described above; and

a display coupled to the display control device and configured to display the image.

Embodiments of the invention will now be described in greater detail, by way of example only, with reference to the accompanying drawings, in which:

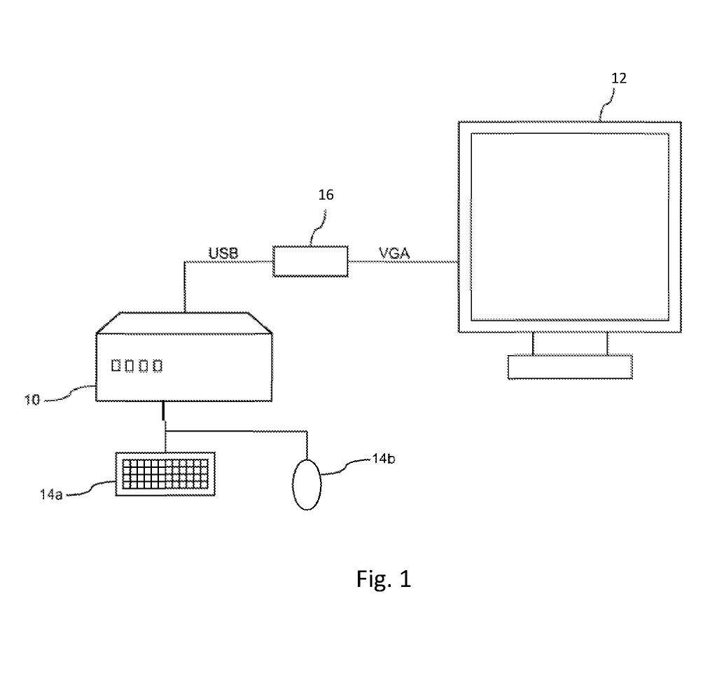

FIG. 1 shows a schematic diagram of components of a display system;

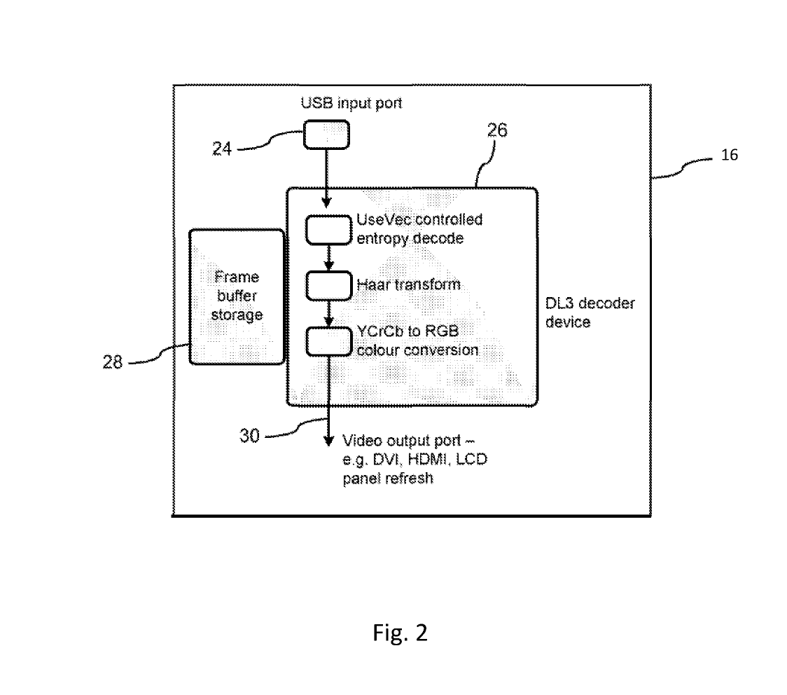

FIG. 2 shows a schematic diagram of a display control device used in the display system of FIG. 1;

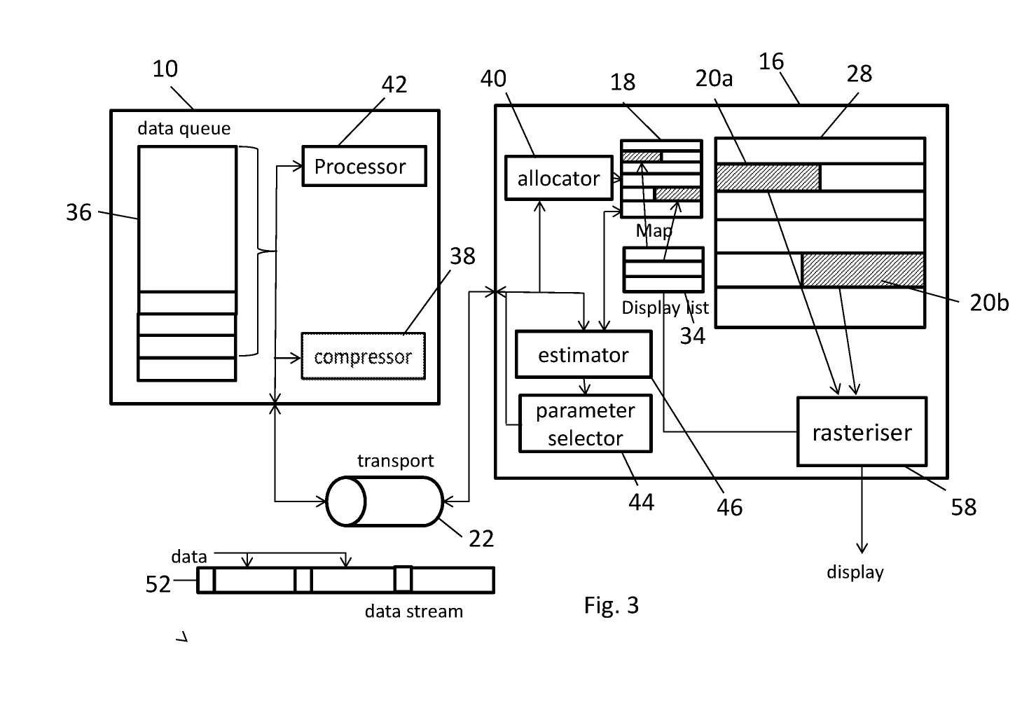

FIG. 3 shows a schematic diagram of one embodiment of a buffer memory management system used in the display system of FIG. 1;

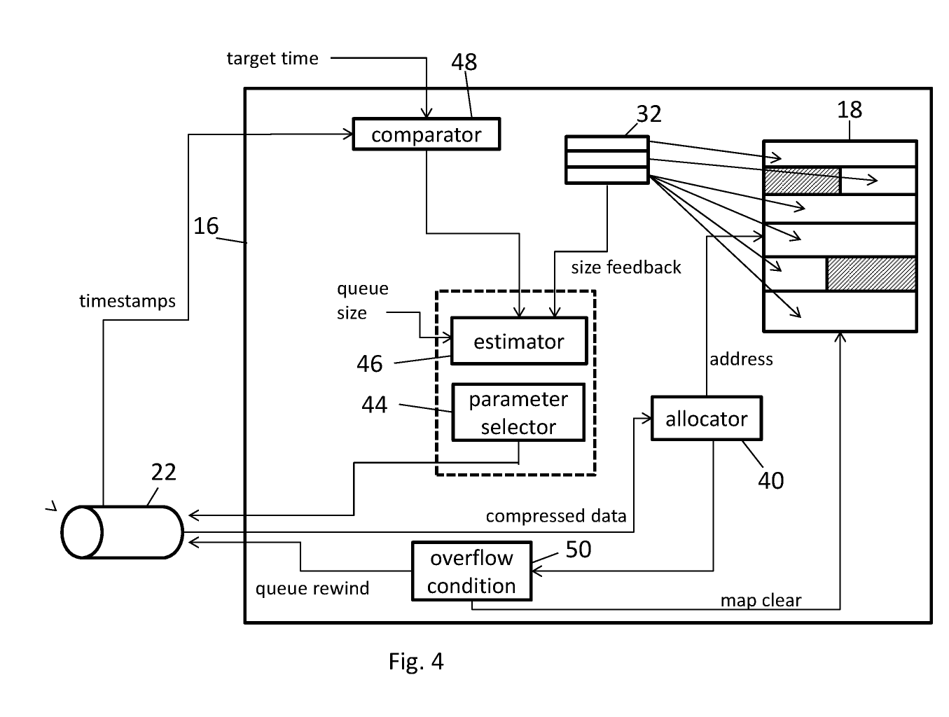

FIG. 4 shows a schematic diagram of part of a processing device used in the buffer memory management system of FIG. 3;

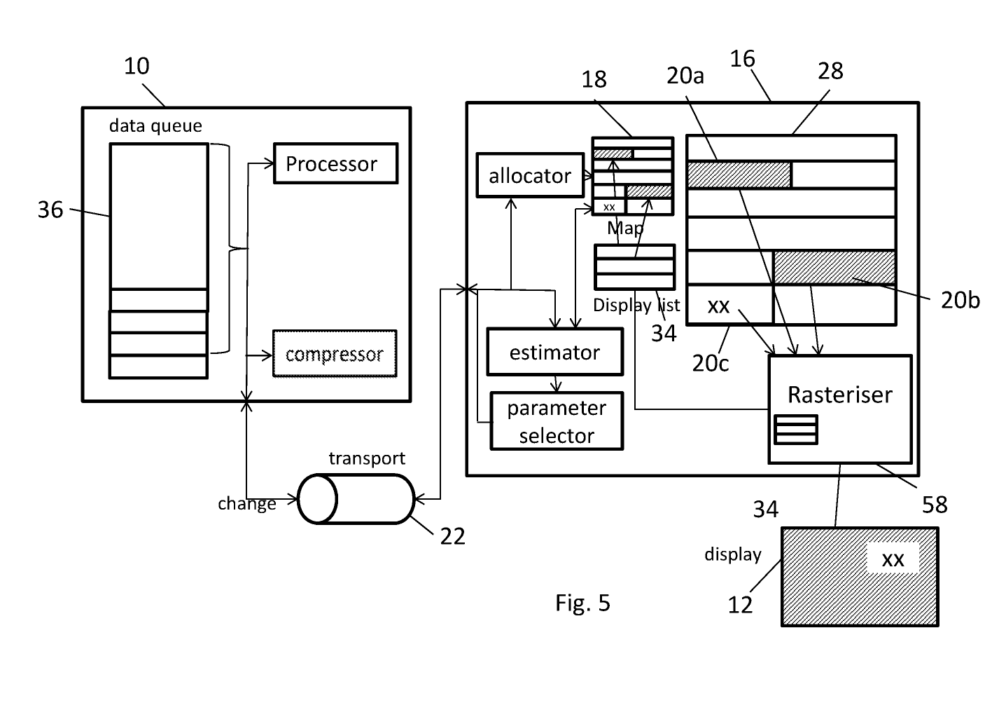

FIG. 5 shows other aspects of the buffer memory management system of FIG. 3.

A display system is shown in FIG. 1. The system comprises a host processing device 10, a display device 12 and user interface devices 14. The user interface devices are a keyboard 14a and a mouse 14b. The system shown in FIG. 1 is a standard desktop computer, with a display device 12, which is composed of discrete components that are locally located but could equally be a device such as a laptop computer or suitably enabled handheld device such as a mobile phone or pda (personal digital assistant) all using an additional display. Similarly, the system may comprise part of a networked or mainframe computing system, in which case the processing device 10 may be located remotely from the user input devices 14 and the display device 12, or indeed may have its function distributed amongst separate devices.

The display device 12 shows images, and the display of the images is controlled by the processing device 10. One or more applications are running on the processing device 10 and these are represented to the user by corresponding application windows, with which the user can interact in a conventional manner. The user can control the movement of a cursor about the images shown on the display device 12 using the computer mouse 14b, again in a totally conventional manner. The user can perform actions with respect to any running application via the user interface device 14 and these actions result in corresponding changes in the images displayed on the display device 12.

The operating system run by the processing device 10 uses virtual desktops to manage one or multiple display devices 12. A physical display device 12 is represented by a frame buffer that contains everything currently shown on that display device 12. In order to allow the display device to be connected to a USB port on the processing device 10, rather than the standard VGA port, as would be the case if the display device 12 is a secondary display device, the processing device 10 connects to the secondary display device 12 via a display control device 16. The display control device 16 is connected to the processing device 10 via a standard USB connection, and appears to the processing device 10 as a USB connected device. Any communications between the processing device 10 and the display control device 16 are carried out under the control of a USB driver specifically for the display control device 16. Such devices allow the connection of the secondary display device 12 to the processing device 10 without the need for any hardware changes to the processing device 10.

The display control device 16 connects to the display device 12 via a standard VGA or HDMI connection, and the display device 12 is a conventional display device 12 which requires no adjustment to operate in the display system shown in FIG. 1. As far as the display device 12 is concerned, it could be connected directly to the graphics card of a processing device; it is unaware that the graphical data displayed by the display device 12 has actually been first sent via a USB connection to an intermediate component, the display control device 16. Multiple additional display devices 12 can be connected to the processing device 10 in this way, as long as suitable USB slots are available on the processing device 10.

The display control device 16 is external to the processing device 10 and is not a graphics card. It is a dedicated piece of hardware that receives graphical data via the USB connection from the processing device 10 and transforms that graphics data into a VGA or HDMI format that will be understood by the display device 12. In topological terms USB and VGA are only examples of data standards that can be used to connect the additional display device 12 to the processing device 10. The general principle is that a general-purpose data network (such as USB or Ethernet) connects the processing device 10 to the display control device 16 and a display-specific data standard (such as VGA, HDMI or DVI) is used on the connection from the display control device 16 to the display device 12.

Part of the display control device 16 is shown in more detail in FIG. 2. The device 16 operates to receive encoded display data via a USB input port 24, which is processed with a processor 26 that is connected to a frame buffer 28 and provides an output via an output port 30. The device 16 is for generating the image that is displayed by the display device 12. The device 16 is effectively an image decoder, as it receives encoded display data which is then decoded to pixel data that is stored within the frame buffer 28.

The incoming signal received by the USB input port 24 comprises encoded display data for one or more pixel tiles or groups of pixel tiles within the image to be displayed. It will be appreciated that the image can be subdivided into any portion of display data that is less than the display data for an entire image, and reduces the amount of data that has to be transmitted between the computer 10 and the display control device 16. A pixel tile comprises an 8×8 array of pixels and the group size could be sixteen pixel tiles, for example, in a 4×4 array of tiles. However, any appropriate portion, or atom, of display data could be used. Often, only an update of part of the image is being sent.

The processor 26 takes the encoded tiles and decodes these tiles into pixel data and updates the frame buffer 28 with the new decoded pixel data. In this way, the frame buffer 28 will always maintain pixel data for the entire image, and this pixel data is continuously being updated by the processor 26. The processor 26 will then output at least a portion of the frame buffer contents via the output port 30 to the display device 12 over the VGA connection. Alternatively, the display control device 16 takes the encoded data, as it arrives from the computer 10 and stores it in the frame buffer in the encoded form. In this embodiment, the processor 26 then decodes the encoded data from the frame buffer 28 as it is required for display.

In a preferred embodiment, the video decoding device (embodied as a silicon chip or an end user product) receives an encoded video signal, decodes the video signal, and outputs the decoded signal to a video display device over a video link such as HDMI, DVI, DP, such that the encoded signal arrives over some variant of the USB interface as standardised by the USB-IF, and the encoded signal makes use of the Haar transform for each 8×8 pixel square of the source images, in each colour channel, AC coefficients of each Haar transform are encoded as variable length bit fields, where the variable encoding is defined using a simple and compact UseVec form (consistent with the definition in the background section). The AC coefficients are ordered so that trailing coefficients represent highest-frequency data, and trailing zero coefficients may be omitted; the colour channels are all at the same resolution, with no subsampling of chroma channels being performed, except as dynamically determined by the number of coefficients provided to the Haar transforms. The encoded signal format is divided into groups of 8×8 tiles so that partial updates of video frame may be performed. Each tile group separately identifies its intended location in the displayed image so that local changes to not require a complete frame update. Each tile group contains fewer than twenty 8×8 tiles and the decoded signal is sent to a video raster display port such as HDMI, DVI, DisplayPort, or is displayed directly on a is visual display which forms part of the device.

FIG. 2 shows one embodiment of the display control device 16, which includes a dedicated frame buffer 28 provided by, for example Random Access Memory (RAM). In other solutions, the frame buffer 28 may not be part of the device 16, but may be present on another separate chip, in which case the processor 26 writes to that frame buffer 28 via a suitable external output port. The display control device 16 may not be a separate device as shown in FIG. 1, but may form part of the actual display device 12. In this case, the output device 30 is not an output port as such, but is the actual display device 12, which is written directly from the frame buffer 28.

As mentioned above, the frame buffer 28 stores portions of data that, together, form the complete image. Nevertheless, managing the frame buffer 28 in order to make efficient use of its memory space, is required. As shown in FIG. 3, the frame buffer 28 includes space for a number of different portions 20 of display data. The portions 20 may be of different sizes, as shown, particularly if they constitute updates of only part of the image. It is therefore desirable that the different sized portions are efficiently packed into the frame buffer 28, so that the least amount of space is wasted between different portions 20. For example, the portion of data 20b would not fit into the space next to portion 20a, since the portion 20b is too big for that space. However, another portion of data may fit into that space next to portion 20a, and it would be more efficient to store it in that space, rather than on another row in the frame buffer 28.

As shown in FIG. 3, in one embodiment, the data is initially held in a data queue 36 in the host device 10, from where individual portions of data are passed, under the control of a processor 42, to a compressor 38, where they are compressed using compression parameters. After compression, the compressed portion of data is passed to the transport mechanism 22 for transfer to the display control device 16.

As can be also be seen in FIG. 3, the display control device 16, is arranged to include a map 18 corresponding to the frame buffer 28. The map is updated to indicate where, in the frame buffer 28, portions 20 of display data have been stored, so that the display control device 16 can best determine where to store further portions 20 of display data. An allocator 40 in the display control device 16 determines the size of the portion of data received by the display control device 16 for storage in the frame buffer 28, the size being variable for different portions 20 of data. The allocator 40 then determines a location on the map 18 where the portion 20 of data would fit in the frame buffer 28. For example, the allocator 40 may maintain a free space list, in which the free spaces in the map 18 are included, together with the sizes of the free spaces. The allocator 40 can then easily determine which is the smallest free space into which the portion of data can fit, thereby maximising the packing efficiency. The address in the frame buffer 28 corresponding to that location in the map 18 is then used by the display control device 16 to store the portion of data at the address in the frame buffer and the location on the map 18 is updated to indicate that the corresponding address(es) in the frame buffer 28 are now full.

The display control device 16 also maintains a list 34 of the portions of data with the order in which they are to be accessed to form the image to be displayed. Therefore, the different portions of the image can then be sent in the correct order to a rasteriser 58 in the display control device 16, from where the image is sent to the display.

It will be appreciated that the display control device 16 may have more than one frame buffer, for example two (or more) frame buffers, which may be provided in the same RAM or in different RAMs. In such a case, of course, the map 18 would map all the frame buffers and there would be separate display lists 34 for each frame buffer to provide the display order for each display buffer. Furthermore, the different frame buffers may be the same size or may have different sizes. If desired, a separate map 18 could be provided for each frame buffer, whether or not they are provided in the same or different RAMs. Each frame buffer may store a frame of image data, so that one frame buffer is being read out and displayed while the second frame buffer is being filled with the next image. Furthermore, as mentioned above, the display data may be compressed by the processing device and sent to the display control device in compressed form. The received compressed data can then be stored in the frame buffer without decompression, and the may only be decompressed when needed for display.

Alternatively, the RAM in the display control device may not be specifically separated into individual frame buffers, but may have one or more memory spaces such that different portions of compressed data of different frames can be sent to addresses in the same memory space such that portions of one frame may be mixed up with portions of another frame. The list 34 then provides the information regarding an order in which the portions of display data in the memory space are to be accessed from the memory space for individual frames and combined to display an image on the display. The display control device can access from the memory the compressed portions of display data for one frame while receiving and storing in the memory compressed portions of display data for another frame.

Furthermore, the allocator 40 can determine the available free space in the frame buffer 28 and can feed the available size of free space to a parameter selector 44, where estimated compression parameters are selected for the compressor 38 to use in compressing the remaining data portions. These estimated compression parameters, once selected, are passed back to the host device 10. Of course, if it is found that the received compressed data portions are substantially too large for available spaces in the frame buffer, then they can be re-estimated to adjust the compression to be more appropriate for the free space in the frame buffer. Indeed, if a particular portion of compressed data is too large to fit into any available free space, new compression parameters can be selected, and passed to the host device 10 with instructions to compress that particular portion of data again, using the newly selected compression parameters. In this way, for example, if the compressed portion of data is too large to fit into an available free space, the allocator 42 can pass the size of the available free space back to the parameter selector 44, which can then select different compression parameters and the portion of data can be compressed again, so that the compressed portion of data will fit into the available free space. The parameter selector may also, of course, select the compression parameters so that the compressed portion of data has an optimum quality, and, if it is found that that there is more available space than would be used for the size of the compressed portion of data, then the compression parameters can be (re)selected to reduce the compression to increase the quality of the compressed portion of data.

Also shown in FIG. 3, an estimator 46, can be used to obtain an estimate of the available free space from the map 18 (for example via the free space list 32 shown in FIG. 4) and can also obtain a size of the data queue 36 still awaiting compression and transfer from the host device 10. The estimator 46 then determines whether the frame buffer 28 has enough space for all the portions of data still in the data queue 36 if they were to be compressed using the normal compression parameters. If the estimator 46 determines that the frame buffer 28 is expected to run out of space before all the display data of the current frame is compressed and sent, the estimator 46 provides that information to the parameter selector 44 so that the compression parameters can be adjusted in order to increase the compression of the portions of display data so that all remaining compressed display data of the current frame will fit into the frame buffer 28. It will be appreciated that although the estimate of free space is described as being determined using the map 18, this is not essential, and any way of determining the available free space could be used.

Apart from determining whether the frame buffer 28 has enough space for all the portions of data still in the data queue 36 if they were to be compressed using the normal compression parameters, the estimator 46 can also control the parameter selector 44 to select the compression parameters based on the time taken to send the compressed portion of data. For example, it is often the case that there is a maximum period of time available for a compressed portion of data to be transmitted from the host device 10. This period may depend on the physical resources available for the transport mechanism 22, or may depend on the transport protocol being used. So, for example, a period of 16 ms may be a maximum period available. It is desirable, therefore, to select compression parameters which would reduce the size of the compressed portion of data sufficiently that it could be sent out in a time less than the maximum period. A target time, for example, 14 ms, may therefore be aimed at. As shown in FIG. 4, a comparator 48 may be used to compare the timestamps from the transport mechanism 22 for previously sent compressed portions of data with the target time, to see whether the target time was being achieved, or whether the actual times for previously sent compressed portions of data were longer or shorter than the target time. Based on that comparison, the estimator 46 can then factor in whether previous compressions were too high or too low to achieve the target time with the optimum quality and can control the parameter selector to select compression parameters accordingly.

It will be appreciated that the target time is the time taken for the host device 10 to send out the compressed portions of data. Alternatively or additionally, the compression parameters can be selected to achieve the optimum quality based on the time taken for the compressed portions of data to be transmitted across the link from the processing device 10 to the display control device 16. This may depend on the resources available across that link.

The compression parameters may also be selected to make sure that frame buffer 28 is filled in time before the frame buffer 28 needs to be accessed for displaying the frame. For example, the time taken for a previous frame to be sent, transmitted and received may be used to select the compression parameters for the next frame. Furthermore, the compression parameters may also be selected based on the content of the previous frame of data. For example, a frame that comprises text may be compressed less than a frame that comprises video data.

Of course, it is possible that the allocator 40 is not be able to find sufficient free space in the frame buffer 28 for a portion of compressed data, even if it was (re) compressed at a higher compression. If the allocator 40 therefore determines that it cannot allocate space in the frame buffer to the compressed portion of data, it notifies an overflow condition 50, which sends a command to clear the map 18 and to the processor 42 of host device 10 to rewind the queue 36 back to the beginning, i.e. to start compressing portions of the frame again. In this case, the parameter selector 44 would select compression parameters from the beginning of the frame to provide a higher compression so that it was more likely that all the frame would fit in the frame buffer. Since the map 18 was cleared, the new compressed portions of data would be allocated any appropriate available space in the frame buffer 28 based on the map 18, and they would, of course, overwrite in the frame buffer 28 anything that was already there. Although this process could be carried out for the existing frame that did not fit, if it were determined that there was not enough time for the frame to be (re)compressed and transmitted to the display control device before it needed to be accessed and displayed, then the frame could be skipped and the next frame could be processed, so that the problem frame was skipped at the display.

Alternatively or additionally, if desired, the display control device 16 can determine quality of a previous portion of display data received from the host device, and send feedback indicative of the quality of the previous portion of display data to the host device. The host device then receives the feedback from the display control device regarding quality of a previous portion of display data and updates the map based on the feedback.

In an embodiment, the host device can determine, based on the map, that the display control device memory requires defragmentation, and can send appropriate instructions to the display control device to perform a defragmentation procedure, and can update the map accordingly. The display control device receives the instructions from the host device, and performs a defragmentation of the memory in response to receiving the instructions.

In another aspect of an embodiment of the invention, the map 18, or a separate map, is maintained showing the various areas of the image. A listing is kept for each of the areas of their age, i.e. when they were last sent and stored in the buffer memory, and their quality, i.e. the compression parameters that were used to compress the portion of display data. These parameters (age and quality) can be used by the parameter selector 44 to adjust the compression parameters to improve the quality of portions of display data that were previously compressed with high compression. If a portion of display data, for example, was previously sent with low quality, then, when the area corresponding to that portion next needs to be resent, it would be desirable, perhaps subject to the constraints described above, to select compression parameters that provide a higher quality, so that the area of the image may be considered to be “healed”. A multiplexer/comparator can receive information as to which areas of the image have changed for which portions of display data are to be compressed. The multiplexer/comparator can then determine whether the corresponding portion of display data previously sent was of low quality, or is of more than a predetermined age, and can then instruct the parameter selector to select compression parameters to compress that portion with a higher quality.

Alternatively or additionally, information regarding when resources may be available could also be used. When resources are available, the multiplexor/comparator can select a particular portion of display data that was previously sent in low quality, or is of more than a predetermined age and insert it into the queue for (re)compression at a higher quality (lower compression) to be (re)sent to the display control device to “heal” the image. The resources that may be available may be resources at the host device for compressing the portions of display data, resources at the display control device for receiving the compressed portions of display data, and/or resources at the transport mechanism for transporting the compressed portions of display data from the host device to the display control device. It may be that when no or little new data is required to be sent, then more and more of the image can be healed in this way by sending through higher quality portions of data than were previously sent.

FIG. 5 shows an embodiment of the system, similar to FIG. 3, in which portion 20c of compressed data stored in the frame buffer 28 is only a partial update of the portion of information for that area of the image. As will be apparent, if an area of the image is generally very similar to the same area in the previous frame, with just a small change (designated by “XX”), then a partial update providing only that small change and otherwise indicating that the rest of the area remains the same as before. This can reduce the amount of data, that needs to be sent from the host device 10 to the display control device 16. The partial update is, of course indicated in the map 18 and the display list 34. The display list 34 is, as previously explained, used by the rasteriser 58 to appropriately access the data from the frame buffer 28 and generate the raster image, with the changed portion XX to the display 12.

Although several embodiments have been described in detail above, it will be appreciated that various changes, modifications and improvements can be made by a person skilled in the art without departing from the scope of the present invention as defined in the claims.

1. A method of managing variable size memory of a display control device connectable to a host device, the memory being used for storing display data sent from the host device to the display control device for displaying on one or more displays, the method comprising:
maintaining a map at the display control device corresponding to the memory, the map indicating locations corresponding to addresses of the memory at which data is stored or not;
receiving a portion of the display data from the host device;
determining a size of the portion of the display data, the size being variable for different portions of data;
determining a location on the map where the portion of display data would fit into the memory;
determining an address in the memory corresponding to the determined location on the map;
storing the portion of display data at the determined address in the memory; and
updating the location on the map corresponding to the address in the memory to indicate that the address has data stored in it.

2. The method according to claim 1, further comprising maintaining an order in which the portions of display data in the memory are to be accessed from the memory and combined to display an image on the display.

3. The method according to claim 1, further comprising determining free space available in the memory based on the map.

4. (canceled)

5. The method according to claim 1 wherein the received portion of display data is compressed at the host device using compression parameters.

6. (canceled)

7. The method according to claim 5, further comprising selecting the compression parameters so that the compressed portion of display data will fit into a free space in the frame buffer memory of the display control device.

8-49. (canceled)

50. The method according to claim 5, wherein the compressed portion of data comprises a tile of display data.

51. The method according to claim 5, wherein the compressed portion of data comprises a group of tiles of display data.

52. The method according to claim 5 further comprising decompressing the compressed portion of display data from the memory prior to combining the portions to form the image.

53. The method according to claim 1, wherein the portion of display data comprises a partial update of the display data including only the display data that has changed from any previous frame.

54. The method according to claim 1, wherein different portions of data may be portions of different frames and may be stored in the memory such that portions of one frame may be mixed up with portions of another frame.

55-63. (canceled)

64. A method of managing a random access memory of a display control device connectable to a host computing device, the memory being used for storing compressed display data forming parts of an image sent from the host device to the display control device, wherein the display control device decompresses the compressed display data from the memory for displaying on a display, the method comprising:
receiving, from the host device, information regarding a size of an uncompressed portion of display data;
determining free space available in the random access memory;
selecting compression parameters so that a compressed version of the uncompressed portion of display data will fit into a free space in the random access memory of the display control device;
providing the selected compression parameters to the host computing device;
determining an address in the memory corresponding to the determined free space in the memory;
receiving, from the host computing device, the compressed portion of display data compressed using the selected compression parameters;
storing the received compressed portion of display data at the determined address in the memory; and
maintaining, at the display control device, information regarding an order in which the portions of compressed display data in the memory are to be decompressed and combined to display the image on the display.

65. The method of claim 64, further comprising:
receiving, from the host device, information regarding a size of a current frame of uncompressed display data;
determining whether the memory of the display control device is expected to run out of space before all the uncompressed display data of the current frame is compressed, received and stored in the memory; and
if it is determined that the frame buffer memory of the display control device is expected to run out of space before all the display data of the current frame is compressed, received and stored, selecting different compression parameters in order to increase the compression of the display data so that all remaining uncompressed display data of the current frame will fit into the memory when it is compressed, and providing the selected different compression parameters to the host device.

66. A method of managing a memory of a display control device connectable to a host device, the memory being used for storing compressed display data sent from the host device to the display control device, wherein the display control device decompresses the compressed data from the memory for displaying on a display, the method comprising:
maintaining a map at the display control device corresponding to a frame buffer memory of the display control device, the map indicating quality of portions of the display data stored at particular addresses in the memory;
determining whether the quality of a compressed portion of the display data previously received by the display control device was of low quality;
determining that resources are available to transmit the compressed portion of display data to the display control device in a higher quality;
selecting compression parameters so that the portion of the display data is of higher quality when it has been compressed;
providing the selected compression parameters to the host computing device;
receiving, from the host computing device, a portion of display data compressed using the selected compression parameters;
storing the received compressed portion of display data at an address in the memory; and
updating the quality on the map corresponding to the address in the frame buffer memory where the portion of compressed display data having higher quality is stored.

67. The method of claim 66, wherein the resources comprise anyone or more of:
resources at the host device for compressing the portions of display data;
resources at the display control device for receiving the compressed portions of display data; and
resources at the transport mechanism for transporting the compressed portions of display data from the host device to the display control device.

68. A display control device connectable to a host device and to a display and comprising:
a computer processing unit; and
memory in data communication with said computer processing unit, said memory having a first portion containing executable instructions for causing said computer processing unit to perform a method of managing a variable size second portion of said memory, said second portion of said memory being used for storing display data sent from the host device to the display control device for displaying on the display, the method including the steps:
maintaining a map at the display control device corresponding to said second portion of said memory, the map indicating locations corresponding to addresses of said second portion of said memory at which data is stored or not;
receiving a portion of the display data from the host device;
determining a size of the portion of the display data, the size being variable for different portions of data;
determining a location on the map where the portion of display data would fit into said second portion of said memory;
determining an address in said second portion of said memory corresponding to the determined location on the map;
storing the received portion of display data at the determined address in said second portion of said memory; and
updating the location on the map corresponding to the address in said second portion of said memory to indicate that the address has data stored in it.

69. The display control device of claim 68, wherein the method further comprises maintaining an order in which the portions of display data in the memory are to be accessed from the memory and combined to display an image on the display.

70. The display control device of claim 68, wherein the method further comprises determining free space available in the memory based on the map.

71. The display control device of claim 68, wherein the received portion of display data is compressed at the host device using compression parameters.

72. The display control device of claim 71, wherein the method further comprises selecting the compression parameters so that the compressed portion of display data will fit into a free space in the frame buffer memory of the display control device.

73. The display control device of claim 71, wherein the compressed portion of data comprises a tile of display data.

74. The display control device of claim 71, wherein the compressed portion of data comprises a group of tiles of display data.

75. The display control device of claim 71, wherein the method further comprises decompressing the compressed portion of display data from the memory prior to combining the portions to form the image.

76. The display control device of claim 68, wherein the portion of display data comprises a partial update of the display data including only the display data that has changed from any previous frame.

77. The display data of claim 68, wherein different portions of data may be portions of different frames and may be stored in the memory such that portions of one frame may be mixed up with portions of another frame.

78. The display control device of claim 68, wherein the display control device in integrated into the display.

79. The display control device of claim 68, further comprising:
a random access memory for storing compressed display data received from the host device;
a decompressor for decompressing the compressed display data from the random access memory for rastering for output to the display, and
a non-volatile programmable memory for storing compressed image data, wherein the decompressor decompresses the compressed image data for rastering for output to the display when it is not required to display the compressed display data from the random access memory.

80. The display control device of claim 68, wherein the display control device is part of a display system also including a host device coupled to the display control device and a display coupled to the display control device and configured to display the image.

81. A display control device connectable to a host device and to a display and comprising:
a computer processing unit; and
memory in data communication with said computer processing unit, said memory having a first portion containing executable instructions for causing said computer processing unit to perform a method of managing a random access memory of a display control device connectable to a host computing device, the memory being used for storing compressed display data forming parts of an image sent from the host device to the display control device, wherein the display control device decompresses the compressed display data from the memory for displaying on a display, the method comprising:
receiving, from the host device, information regarding a size of an uncompressed portion of display data;
determining free space available in the random access memory;
selecting compression parameters so that a compressed version of the uncompressed portion of display data will fit into a free space in the random access memory of the display control device;
providing the selected compression parameters to the host computing device;
determining an address in the memory corresponding to the determined free space in the memory;
receiving, from the host computing device, the compressed portion of display data compressed using the selected compression parameters;
storing the received compressed portion of display data at the determined address in the memory; and
maintaining, at the display control device, information regarding an order in which the portions of compressed display data in the memory are to be decompressed and combined to display the image on the display.

82. The display control device of claim 81, wherein the method further comprises:
receiving, from the host device, information regarding a size of a current frame of uncompressed display data;
determining whether the memory of the display control device is expected to run out of space before all the uncompressed display data of the current frame is compressed, received and stored in the memory; and
if it is determined that the frame buffer memory of the display control device is expected to run out of space before all the display data of the current frame is compressed, received and stored, selecting different compression parameters in order to increase the compression of the display data so that all remaining uncompressed display data of the current frame will fit into the memory when it is compressed, and providing the selected different compression parameters to the host device.

83. The display control device of claim 81, wherein the display control device in integrated into the display.

84. The display control device of claim 81, further comprising:
a random access memory for storing compressed display data received from the host device;
a decompressor for decompressing the compressed display data from the random access memory for rastering for output to the display, and
a non-volatile programmable memory for storing compressed image data, wherein the decompressor decompresses the compressed image data for rastering for output to the display when it is not required to display the compressed display data from the random access memory.

85. The display control device of claim 81, wherein the display control device is part of a display system also including a host device coupled to the display control device and a display coupled to the display control device and configured to display the image.

86. A display control device connectable to a host device and to a display and comprising:
a computer processing unit; and
memory in data communication with said computer processing unit, said memory having a first portion containing executable instructions for causing said computer processing unit to perform a method of managing a memory of a display control device connectable to a host device, the memory being used for storing compressed display data sent from the host device to the display control device, wherein the display control device decompresses the compressed data from the memory for displaying on a display, the method comprising:
maintaining a map at the display control device corresponding to a frame buffer memory of the display control device, the map indicating quality of portions of the display data stored at particular addresses in the memory;
determining whether the quality of a compressed portion of the display data previously received by the display control device was of low quality;
determining that resources are available to transmit the compressed portion of display data to the display control device in a higher quality;
selecting compression parameters so that the portion of the display data is of higher quality when it has been compressed;
providing the selected compression parameters to the host computing device;
receiving, from the host computing device, a portion of display data compressed using the selected compression parameters;
storing the received compressed portion of display data at an address in the memory; and
updating the quality on the map corresponding to the address in the frame buffer memory where the portion of compressed display data having higher quality is stored.

87. The display control device of claim 86, wherein the resources comprise anyone or more of:
resources at the host device for compressing the portions of display data;
resources at the display control device for receiving the compressed portions of display data; and
resources at the transport mechanism for transporting the compressed portions of display data from the host device to the display control device.

88. The display control device of claim 86, wherein wherein the display control device in integrated into the display.

89. The display control device of claim 86, further comprising:
a random access memory for storing compressed display data received from the host device;
a decompressor for decompressing the compressed display data from the random access memory for rastering for output to the display, and
a non-volatile programmable memory for storing compressed image data, wherein the decompressor decompresses the compressed image data for rastering for output to the display when it is not required to display the compressed display data from the random access memory.

90. The display control device of claim 86, wherein the display control device is part of a display system also including a host device coupled to the display control device and a display coupled to the display control device and configured to display the image.

91. A non-transitory computer-readable storage medium, the computer-readable storage medium including instructions relating to storing display data sent from the host device to the display control device for displaying on one or more displays that when executed by a computer, cause the computer to:
maintain a map at the display control device corresponding to the memory, the map indicating locations corresponding to addresses of the memory at which data is stored or not;
receive a portion of the display data from the host device;
determine a size of the portion of the display data, the size being variable for different portions of data;
determine a location on the map where the portion of display data would fit into the memory;
determine an address in the memory corresponding to the determined location on the map;
store the received portion of display data at the determined address in the memory; and
update the location on the map corresponding to the address in the memory to indicate that the address has data stored in it.

92. A non-transitory computer-readable storage medium, the computer-readable storage medium including instructions relating to storing compressed display data forming parts of an image sent from the host device to the display control device, wherein the display control device decompresses the compressed display data from the memory for displaying on a display and the instructions, when executed by a computer, cause the computer to:
receive, from the host device, information regarding a size of an uncompressed portion of display data;
determine free space available in the random access memory;
select compression parameters so that a compressed version of the uncompressed portion of display data will fit into a free space in the random access memory of the display control device;
provide the selected compression parameters to the host computing device;
determine an address in the memory corresponding to the determined free space in the memory;
receive, from the host computing device, the compressed portion of display data compressed using the selected compression parameters;
store the received compressed portion of display data at the determined address in the memory; and
maintain, at the display control device, information regarding an order in which the portions of compressed display data in the memory are to be decompressed and combined to display the image on the display.

93. The non-transitory computer-readable storage medium of claim 92, wherein the instructions further cause the computer to:
receive, from the host device, information regarding a size of a current frame of uncompressed display data;
determine whether the memory of the display control device is expected to run out of space before all the uncompressed display data of the current frame is compressed, received and stored in the memory; and
if it is determined that the frame buffer memory of the display control device is expected to run out of space before all the display data of the current frame is compressed, received and stored, select different compression parameters in order to increase the compression of the display data so that all remaining uncompressed display data of the current frame will fit into the memory when it is compressed, and providing the selected different compression parameters to the host device.

94. A non-transitory computer-readable storage medium, the computer-readable storage medium including instructions relating to storing compressed display data sent from the host device to the display control device, wherein the display control device decompresses the compressed data from the memory for displaying on a display, and the instructions, when executed by a computer, cause the computer to:
maintain a map at the display control device corresponding to a frame buffer memory of the display control device, the map indicating quality of portions of the display data stored at particular addresses in the memory;
determine whether the quality of a compressed portion of the display data previously received by the display control device was of low quality;
determine that resources are available to transmit the compressed portion of display data to the display control device in a higher quality;
select compression parameters so that the portion of the display data is of higher quality when it has been compressed;
provide the selected compression parameters to the host computing device;
receive, from the host computing device, a portion of display data compressed using the selected compression parameters;
store the received compressed portion of display data at an address in the memory; and
update the quality on the map corresponding to the address in the frame buffer memory where the portion of compressed display data having higher quality is stored.

95. The non-transitory computer-readable storage medium of claim 94, wherein the resources comprise anyone or more of:
resources at the host device for compressing the portions of display data;
resources at the display control device for receiving the compressed portions of display data; and
resources at the transport mechanism for transporting the compressed portions of display data from the host device to the display control device.
